(19) United States
(12) Patent Application Publication
(10) Pub. No.: US 2011/0134931 A1
(43) Pub. Date: Jun. 9, 2011

(54) Virtual router migration

(76) Inventors: Jacobus Van Der Merwe, New Providence, NJ (US); Jennifer Lynn Rexford, Princeton, NJ (US); Yi Wang, Princeton, NJ (US)

(21) Appl. No.: 12/653,079

(22) Filed: Dec. 8, 2009

(51) Int. Cl. H04L 12/56

(52) U.S. Cl. 370/401

(57) ABSTRACT

A Virtual Router (VR) is described that can move freely from one physical router to another in a network. Embodiments enable a network operator to configure a network management primitive that supports live migration of VRs from one physical router to another. To minimize disruptions, VRs allow a migrated control plane from a source router to clone its data plane state from the source router at a destination router while continuing to update its data plane state at the source router. Embodiments temporarily forward packets using both router location data planes to support asynchronous migration of links.

### BACKGROUND OF THE INVENTION

The invention relates generally to network engineering. More specifically, the invention relates to systems and methods that enable Virtual Routers (VRs) to move freely from one physical router to another in a network.

Network management is widely recognized as one of the most important challenges facing the Internet. The cost of people and systems that manage a network typically exceeds the cost of the underlying nodes and links. Additionally, most network outages are caused by operator errors, rather than equipment failures.

From routine tasks such as planned maintenance to the less frequent deployment of new protocols, network operators struggle to provide seamless service in the face of changes to the underlying network. Handling change is difficult because each change to the physical infrastructure requires a corresponding modification to the logical configuration of routers, such as reconfiguring tunable parameters in the routing protocols.

Logical configuration refers to IP packet forwarding functions and physical infrastructure refers to physical router equipment such as line cards, interfaces, etc., that enables the logical functions. Any inconsistency between logical and physical configurations can lead to unexpected reachability or performance problems. Because of today's tight coupling between the physical and logical topologies, network operators sometimes make extra logical layer changes to handle physical changes more gracefully. A classic example is increasing link weights in Interior Gateway Protocol (IGP) to cost-out a router in advance of planned maintenance. In this case, a change in the logical topology is not the goal, rather it is an indirect tool available to achieve the task at hand, and it does so with potential negative side effects.

Realizing network configuration changes presents several challenges. 1) migratable routers—To make a router migratable, its router functionality must be separable from the physical equipment on which it runs. 2) minimal outages—To avoid disrupting user traffic or triggering routing protocol reconvergence, migration should cause no or minimal packet loss. 3) migratable links—To keep the Internet Protocol (IP) layer topology intact, the links attached to a migrating router must follow it to its new location.

The goal is to migrate router functionality from one physical piece of equipment to another without any discernible impact. Without requiring the router to be reconfigured, without disturbing the IP layer topology, without triggering protocol reconvergence and without disrupting data traffic.

Router migration could leverage straight forward extensions to existing virtual machine migration techniques. This would involve copying the router image (including routing protocol binaries, configuration files and data plane state) to a new physical router and freezing the running processes before copying them. The processes and data plane state are then restored on the new physical router and associated with the migrated links. However, the delays in completing these steps may cause unacceptable disruptions for both the data traffic and the routing protocols. For router migration to be viable, packet forwarding should not be interrupted. In contrast, the control plane can tolerate brief disruptions since routing protocols have their own retransmission mechanisms. The control plane must restart quickly at the new location to avoid losing protocol adjacencies with other routers and to minimize delay in responding to unplanned network events.

Link migration means the change of physical port(s) (end point(s)) of a direct physical link. However, in layered network architectures, direct physical links are typically subsumed by transport networks that are capable of performing port remapping (link migration) through transport layer switching. Links are not necessarily physical, but may be virtualized by a number of tunneling technologies which can exist either in the transport layer or in the IP layer. Variants of link migration are enabled by programmable circuit-based transport networks and tunnel-based virtual links are enabled by packet-based transport networks.

Recent advances in programmable transport networks allow physical links between routers to be dynamically set up and torn down. FIG. 1A shows Router A, Router B and Router C coupled together by a Programmable Transport Network through two or more optical transport switches. The link between physical Routers A and B (solid line) is switched through the network so that the same physical port on Router A may be connected to Router C after a link switch-over inside the transport network (broken line). This type of link switch-over may be performed efficiently at the transport layer. For example, sub-nanosecond optical switching time may be employed and performed across a Wide Area Network (WAN) of transport switches which enables inter-Point-of-Presence (POP) link migration and access link migration between POPs.

Current programmable transport networks are circuit oriented in nature meaning either a Time Division Multiplexed (TDM) circuit or an optical wavelength is the unit that is switched in the programmable network. One drawback of circuit-based transport access networks is that a customer access port is directly bound to a Provider Edge (PE) router to which it connects. Therefore, a dedicated physical port on the PE router is required for every customer access router interface.

In contrast, commercial access networks are evolving to packet-aware transport networks which eliminate the need for per-customer physical ports on PE routers. In a packet-aware access network (e.g., a virtual private Local Area Network (LAN) service access network), each customer access port is associated with a label or a pseudo-wire which allows a PE router to support multiple logical access links on the same physical port. FIG. 1B shows in Router A, a link migration from Router A to Router B, to Router A to Router C performed by switching from one logical link (continuous tunnel) to another logical link (broken tunnel) that shares the same physical interface.

Network virtualization has been proposed in various contexts. Early work includes the switchlets concept, in which Asynchronous Transfer Mode (ATM) switches are partitioned to enable dynamic creation of virtual networks. More recently, the CABO (Concurrent Architectures are Better than One) architecture proposes to use virtualization as a means to enable multiple service providers to share the same physical infrastructure.

A measurement study of a large Internet Service Provider (ISP) showed that more than half of routing changes were planned in advance. Network operators can limit the disruption by reconfiguring the routing protocols to direct traffic away from the equipment undergoing maintenance. In addition, extensions to the routing protocols can allow a router to continue forwarding packets in the data plane while reinstalling or rebooting the control plane software. However, these techniques require changes to the logical configuration or the routing software, respectively.

Deploying new services, like Internet Protocol version 6 (IPv6) or Internet Protocol television (IPTV), is the life blood of any ISP. Yet, ISPs must exercise caution when deploying these new services. First, they must ensure that the new services do not adversely impact existing services. Second, the necessary support systems need to be in place before services can be properly supported. Support systems include configuration management, service monitoring, provisioning and billing. Therefore, ISPs usually start with a small trial running in a controlled environment on dedicated equipment, supporting a few early adopter customers. However, this leads to a “success disaster” when the service warrants wider deployment. The ISP wants to offer seamless service to its existing customers, and yet also restructure their test network, or move the service onto a larger network to serve a larger set of customers. This trial system success dilemma is hard to resolve if the logical notion of a network node remains bound to a specific physical router.

In 2000, the total energy consumed by the estimated 3.26 million operating routers in the United States was about 1.1 Tera-Watt hours (TWh). This number was expected to grow to 1.9 to 2.4 TWh during the year 2005 by three different projection models, which translates into an annual cost of about 178-225 million US dollars. These numbers do not include the energy consumed by their cooling systems.

Although designing energy efficient equipment is clearly an important part of the solution, network operators can also manage a network in a more power efficient manner. Previous studies have reported that Internet traffic has a consistent diurnal pattern caused by human interactive network activities. However, today's routers are surprisingly power insensitive to the traffic loads they are handling. An idling router consumes over 90% of the power it requires when operating at its maximum capacity.

Realizable Virtual Routers (VRs) can exploit the variations in daily traffic volume to reduce power consumption. The size of a physical network can be expanded and shrunk according to traffic demand, by hibernating or powering down routers that are not needed.

Deciding when and where to migrate VRs in the power savings case is a constraint optimization problem. The objective of the problem is to maximize the power savings that can be achieved (in a day), given the granularity of the migration (once every hour, according to the hourly traffic matrices), and the power prices in different geographical locations, which can vary substantially. The constraints include the maximum path stretch the operators are willing to tolerate, as well as the same four physical constraints discussed above (link capacity, platform capacity, router capability and router capacity).

The challenge is to allow network operators to migrate router functionality from one physical device to another without operational impacts. To achieve this, a system and method is needed that realizes VRs.

### SUMMARY OF THE INVENTION

The inventors have discovered that it would be desirable to have systems and methods that enable VRs to move freely from one physical router to another in a network that employs routers, Transmission Control Protocol/Internet Protocol (TCP/IP) or related packet networks. Embodiments enable a network operator to configure a network management primitive that supports the live migration of a VR from a source router to a destination router. To minimize disruptions, VRs allow a migrated VR's control plane from a source router to clone its data plane state available at the source router, at the destination router, while continuing to update the data plane state at the source router. Embodiments temporarily forward packets using the source router and destination router data planes to support asynchronous migration of network links from the source router to the destination router.

Embodiments configure network routers as carrier substrates on which VRs operate. A VR may migrate to a different router without disrupting the flow of traffic or changing the logical topology, obviating the need to reconfigure the VR while also avoiding routing protocol convergence delays. If a router undergoes planned maintenance, one or more resident VRs could move in advance to one or more destination routers in the same POP. Additionally, PE routers may move from one location to another by virtually re-homing its links that connect to neighboring domains.

Embodiments may be applied to commercial router platforms and do not disrupt data planes. Only the control plane briefly freezes. In an unlikely scenario where a control plane event occurs during the freeze, the effects are largely hidden by existing mechanisms for retransmitting routing protocol messages. Transport networks support rapid set-up and tear-down of links, enabling the network topology to change underneath the IP routers. Dynamic topologies coupled with control plane migration and cloning of the data plane make the router an ephemeral concept and not tied to a particular location or hardware device.

One aspect of the invention provides a method for a packet-aware transport network to allow a Virtual Router (VR) to migrate from a source router to a destination router. Methods according to this aspect of the invention include prior to migrating a VR, searching for a destination router that does not increase path stretch and is in accordance with physical constraints, receiving a migrate order at a source router and at a destination router from a Network Management System (NMS) to migrate a VR, establishing temporary tunnels between the source router and destination router, copying the VR's configuration files at the source router to the file system at the destination router, cloning the data plane for the migrated VR at the destination router, redirecting all routing messages destined to the VR at the source router to the destination router, migrating each link to and from the source router to the destination router, migrating each link independently of the others, and after all links are migrated to the destination router, removing the VR data plane at the source router and the temporary tunnels.

Another aspect of the invention is a router architecture that provides router virtualization, control and data plane separation, and dynamic interface binding which enables one or more resident Virtual Routers (VRs) to migrate to another router. Router architectures according to this aspect of the invention include a physical substrate coupled to one or more physical interfaces and coupled to one or more tunnel interfaces, a data plane hypervisor configured to interface between the physical substrate and one or more VR control planes and their respective data planes, and decouple VR control plane software from VR control plane state, a VR's control and data plane separation allows the router architecture to migrate the control and data planes of a VR separately, and a dynamic interface binding configured to allow data structures associated with a particular VR data plane to be dynamically associated with different physical interfaces wherein the isolation between the one or more VRs allows migration of one resident VR without affecting another resident VR and enables VR migration and link migration by dynamically setting-up and changing the binding between a VR's Forwarding Information Base (FIB) and its substrate physical interfaces and tunnel interfaces.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is an exemplary programmable transport network link migration.

FIG. 1B is an exemplary packet-aware transport network link migration.

FIG. 2 is an exemplary router configuration embodiment that supports VR migration.

FIGS. 3A, 3B, 3C and 3D is an exemplary network showing VR migration between router A and router B.

FIG. 4 is an exemplary timing diagram of VR migration.

FIG. 5 is an exemplary method.

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting, and coupling. Further, “connected” and “coupled” are not restricted to physical or mechanical connections or couplings.

It should be noted that the invention is not limited to any particular software language described or that is implied in the figures. One of ordinary skill in the art will understand that a variety of alternative software languages may be used for implementation of the invention. It should also be understood that some of the components and items are illustrated and described as if they were hardware elements, as is common practice within the art. However, one of ordinary skill in the art, and based on a reading of this detailed description, would understand that, in at least one embodiment, components in the method and system may be implemented in software or hardware.

Embodiments of the invention provide methods, system frameworks, and a computer-usable medium storing computer-readable instructions that supports live migration of VRs from one router to another. The invention may be implemented as a modular framework and deployed as software as an application program tangibly embodied on a program storage device. The application code for execution can reside on a plurality of different types of computer readable media known to those skilled in the art.

A router is an electronic device and/or software that connect at least two networks, such as two Local Area Networks (LANs) or Wide Area Networks (WANs), and forwards packets between them. Each packet can traverse many routers, making many hops throughout the Internet as well as multiple routers within a large organization.

A next hop is the next router to which a packet is sent from any given router as it traverses a network from its source to its destination. In the event that the packet is at the final router in its journey, the next hop is the final destination. A hop is the trip that a packet takes from one router to another or from the final router to the destination. A packet, also referred to as a datagram, is a fundamental unit of data transmission on the Internet and other TCP/IP networks.

Routers forward data packets between networks using headers and forwarding tables to determine the best path to forward the packets. Routers work at the network layer of the TCP/IP model or layer 3 of the OSI model. Routers also provide interconnectivity between like and unlike media. This is accomplished by examining the header of a data packet, and making a decision on the next hop to which it should be sent. Routers use preconfigured static routes, status of their hardware interfaces, and routing protocols to select the best route between any two subnets.

The next hop for any particular packet at any particular point in its journey is determined, for example, in the Internet by both the IP address of its destination as contained in its header and the routing table in the router at that point. An IP address is a unique numeric identifier for each computer or router on a TCP/IP network. A routing table is a database in a router that stores and frequently updates the IP addresses of reachable networks, called “routes” or “prefixes,” and the most efficient path to them.

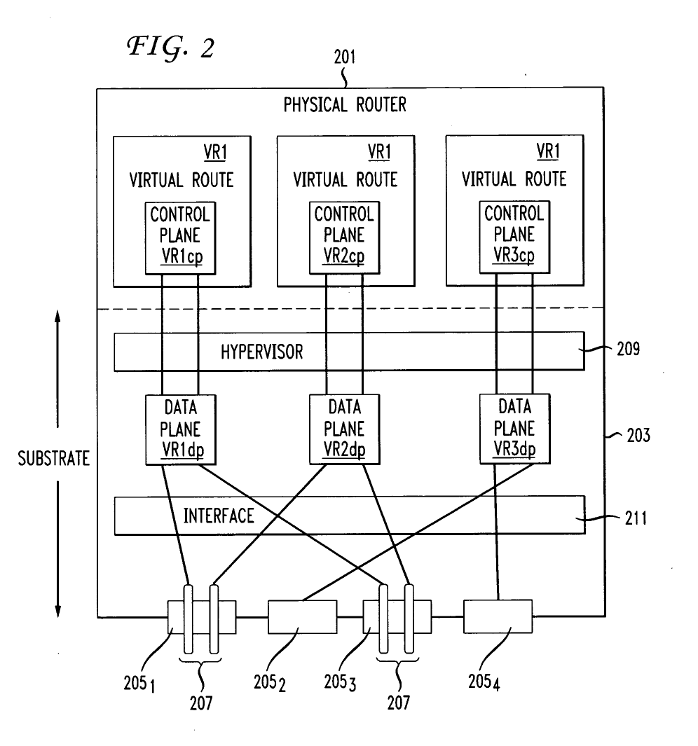

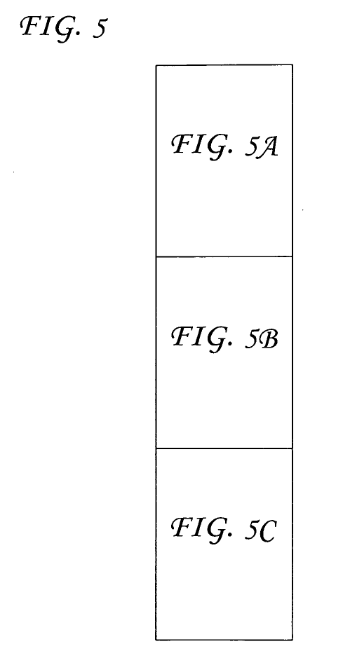

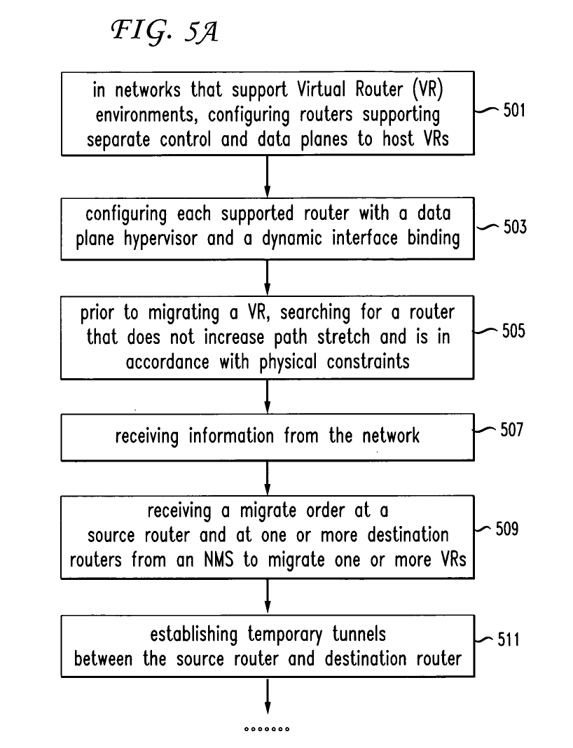

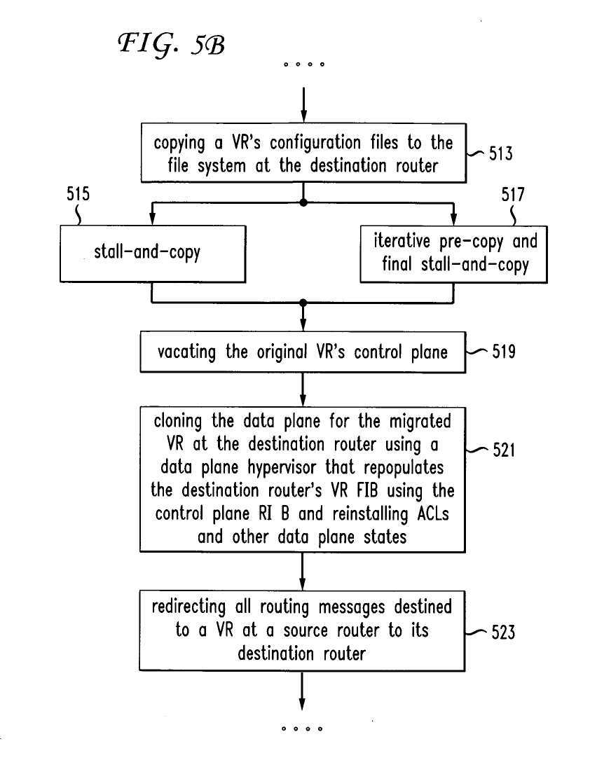

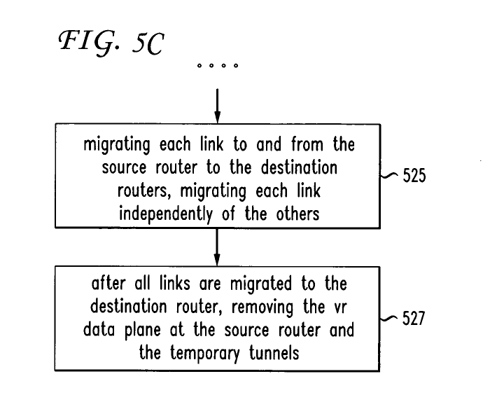

FIG. 2 shows a router embodiment 201 that supports VR migration. FIG. 5 shows a VR migration method.

The router 201 architecture provides for router virtualization, control and data plane separation, and dynamic interface binding which enable VR migration. The router 201 comprises a physical substrate 203, physical interfaces 205₁, 205₂, 205₃, 205₄, tunnel interfaces 207, a data plane hypervisor 209 and a dynamic interface binding 211. The data plane hypervisor 209 is an interface between VR instance VR1, VR2, VR3 and their respective control planes VR1cp, VR2cp, VR3p and data planes VRldp, VR2dp, VR3dp, and enables the VRs VR1, VR2, VR3 to migrate between different types of data planes. There may be any number of VRs VRₙ.

Unlike servers, modern routers have physically separate control and data planes. To enable a VR to migrate across different data plane platforms, the data plane hypervisor 209 leverages the advantages of the separate control and data planes. The data plane hypervisor 209 decouples the control plane software from the control plane state (e.g., Routing Information Bases (RIBs)). The data plane hypervisor 209 is a hardware/software interface realization that allows for upgrading router software easier and for VRs to migrate between routers that run different code bases. The hypervisor 209 comprises three modules that 1) separate the forwarding tables from container contexts, 2) push forwarding table entries into the separate data plane and 3) dynamically bind virtual interfaces and forwarding tables. The hypervisor 209 provides live migration of VRs between two data plane platforms.

During VR migration, service disruptions are minimized by leveraging the separation of the control and data planes in modern routers. The data plane hypervisor 209 is a migration aware interface between the control and data planes. The hypervisor 209 is a unified interface that supports migration between physical routers with different data plane technologies. Embodiments migrate only a VR's control plane, while continuing to forward traffic through the data plane. The VR's control plane can start running at the new destination router location, and populate a new data plane at the destination router location while updating the data plane at the source router location in parallel.

The dynamic interface binding 211 may be a configurable switching fabric local to the router that allows data structures associated with a particular VR data plane, (the forwarding tables) to be dynamically associated with different physical interfaces.

The router 201 partitions the resources of a physical router to support multiple VR instances VR1, VR2, VR3. The control plane runs in the physical control processor of the router and the data plane may be a partition of the physical router data plane. Each VR VR1, VR2, VR3 runs independently with its own control plane VR1cp, VR2cp, VR3cp (e.g., applications, configurations, routing protocol instances and RIB) and data plane VRldp, VR2dp, VR3dp (e.g., interfaces and Forwarding Information Base (FIB)). The isolation between the VRs VR1, VR2, VR3 makes it possible to migrate one VR VR1 without affecting the other VRs VR2, VR3.

In the router 201, the virtual router control planes VR1cp, VR2cp, VR3cp and data planes VR1dp, VR2dp, VR3dp run in separate environments. The VR VR1, VR2, VR3 control planes are hosted in separate virtual environments while their data planes reside in the substrate 203 where each data plane is kept in a separate data structure with its own state information, such as FIB entries, Access Control Lists (ACLs), etc. Separation of control and data planes exists in commercial routers in which the control plane runs in the CPU and main memory, and the data plane is hosted in the line cards which have their own computing power for packet forwarding and memory to store the FIBs. The control and data plane separation allows the router 201 to migrate the control and data planes of a virtual router separately.

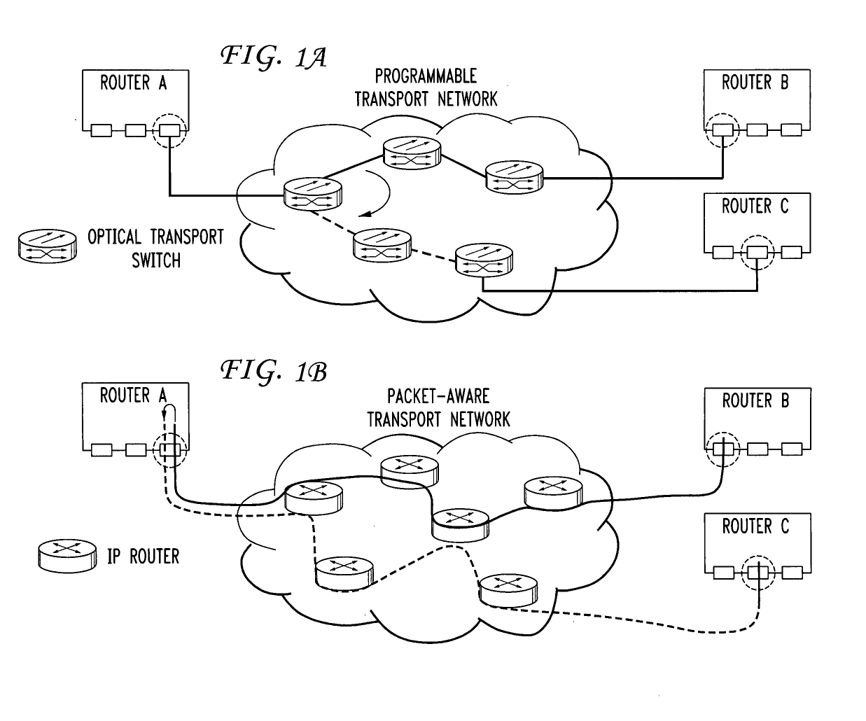

To enable VR migration and link migration, the router 201 dynamically sets-up and changes the binding between a VR's FIB and its substrate interfaces (which may be physical or tunnel interfaces). The existing interface binding mechanism in today's routers is used to map interfaces with virtual routers. Router 201 embodiments require two extensions. First, after a VR is migrated, the binding needs to be reestablished dynamically on the destination router. This is the same as if the VR were just instantiated on the source router. Second, link migration in a packet-aware transport network (FIG. 1B) involves changing tunnel interfaces in the router. For link migration, the router 201 substrate 203 switches the binding from old tunnel interfaces to new tunnel interfaces on-the-fly.

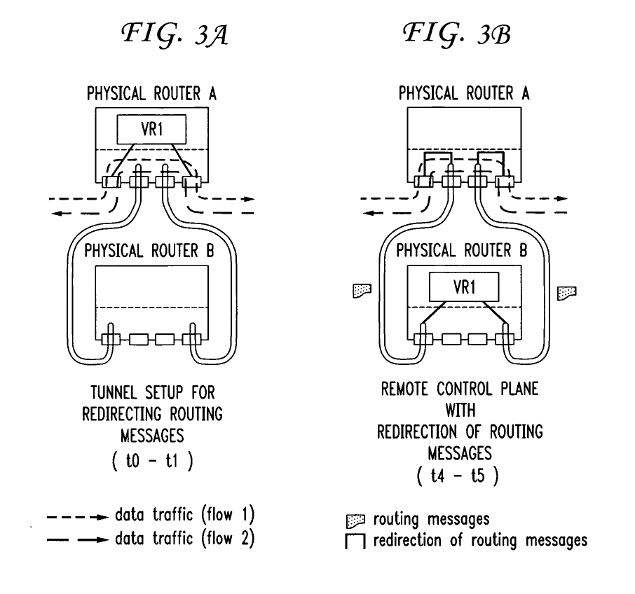

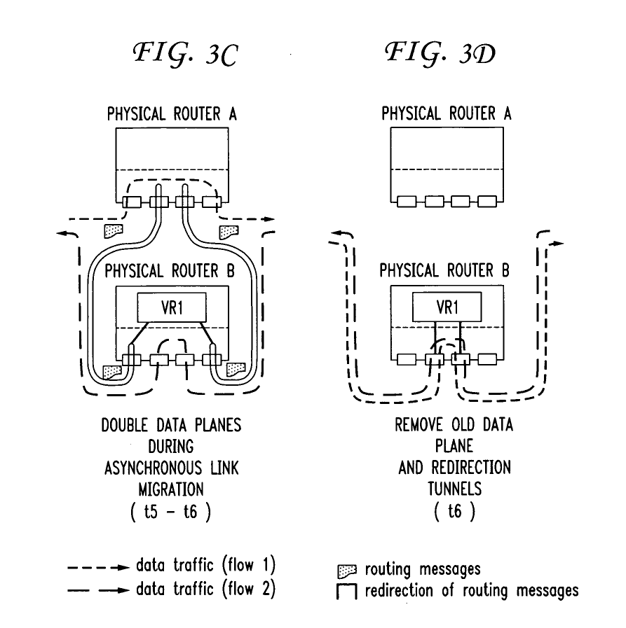

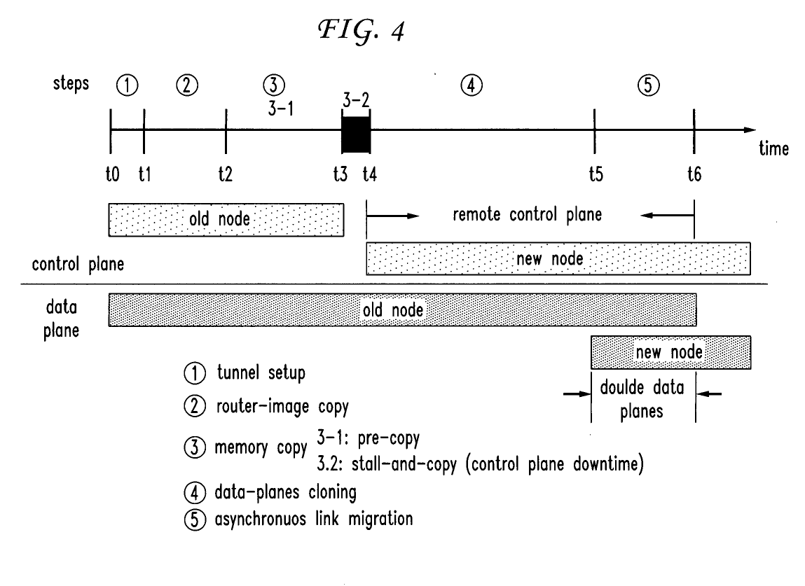

FIGS. 3A-D and 4 show VR migration. Routers that support separate control and data planes are configured using embodiments with a data plane hypervisor 209 and a dynamic interface binding 211 to enable VR migration (steps 501, 503). FIG. 4 shows a timing diagram relating five major activities performed by embodiments for VR migration between a source router (old node) and a destination router (new node) and when the VR's control plane and data plane at the source router hand-off to the destination router. The shared activities are 1) tunnel setup, 2) router image copy, 3) memory copy, 4) data plane cloning and 5) asynchronous link migration.

VR's leverage Virtual Machine (VM) migration techniques to migrate a control plane. Unlike general purpose VMs that can potentially be running completely different programs, VRs from the same vendor run the same, albeit usually small set of programs (e.g., routing protocol suites). Embodiments use the same set of binaries (the control plane software of the router, routing protocol daemons, management daemons, etc.) on each physical router.

To perform planned maintenance tasks, network operators may migrate the VRs running on a router to other routers before performing maintenance and migrate them back afterwards as needed without needing to reconfigure any routing protocols, disrupt traffic or deal with protocol reconvergence. Migration instructions would originate from an operator's control framework or Network Management System (NMS).

For a router that requires maintenance, network operators need to decide where to migrate the VRs that are currently hosted on that router. A greedy algorithm may be used to search for one or more suitable routers to maintain or minimize path stretch (latency increase) after a VR migrates. A greedy algorithm does not effect a global optimization, only a local optimal choice. For example, to migrate router A, the algorithm examines where the router may be moved so that a particular metric is optimized without considering whether the decision will have an impact on subsequent migrations. This process can be readily repeated assuming planned maintenance is being performed on a small number of routers at a time.

Several physical constraints need to be taken into consideration when performing the search. 1) Link capacity—migrating a VR moves its traffic load to a new set of underlying links. The new links should have sufficient unused capacity to accommodate the extra traffic. 2) Platform compatibility—routers from different vendors may not use the same operating system, routing software, or migration mechanisms, making it difficult to move a VR from one vendor platform to another. 3) Router capability—different router models from the same vendor may have different capabilities. For example, routers may differ in the number of Access Control Lists (ACLs) they can support. 4) Router capacity—whether a physical router is already hosting the maximum number of VRs it can support. Fortunately, ISPs typically leave enough head room in link capacities to absorb sudden volume increases. Additionally, most ISPs use routers from one or two vendors, with a small number of models, which allows for a ready pool of physical routers that can host the VRs (step 505).

To migrate a VR, embodiments consider the above four points and preserve the same latency. Network intelligence is realized through a separate control framework (not shown) that receives information from the network and provides operators with an interface to specify network management instructions to issue orders to a source and destination router to migrate. (steps 507, 509).

VR migration begins by establishing tunnels between a VR resident on a source router A and a destination physical router B (step 511). A tunnel may be created by encapsulating traffic that would normally not be routable between routers A and B in packets, that are routable between A and B so that the traffic is tunneled between the two routers. FIG. 3A shows bidirectional tunnels established between source router A and destination router B. The tunnels allow VR1's control plane VR1cp located on router A to send and receive routing messages after it migrates its control plane VR1cp to router B (FIG. 4, timing steps 1, 2 and 3) but before link migration completes. The tunnels allow the migrated control plane VR1cp to keep its data plane VR1dp on source router A up-to-date (FIG. 3B). The links of a VR should follow its migration from a source router to its destination router. Although VR1's control plane VR1cp may experience a short period of downtime during memory copy (FIG. 4, timing step 3-2), the data plane VR1dp at source router A continues operating during the entire migration process.

After tunnels are established, the VR's control plane binaries are locally copied to the file system at the destination router. Only the router configuration files need to be copied over the network reducing the total migration time (as local-copy is usually faster than network-copy) (step 513).

Two items that need to be dealt with when migrating a VR control plane are 1) the virtual router image, such as routing protocol binaries and network configuration files, and 2) the virtual router memory, which includes the states of all the running processes.

When copying the VR image and memory, the total migration time and the control plane downtime must be minimized. That is the time between when VR1's control plane VR1cp is check-pointed (execution is stopped) at the source router A and when it is copied and resumed at the destination router B. This is because, although routing protocols can usually tolerate a brief network glitch using retransmission (e.g., Border Gateway Protocol (BGP) uses Transmission Control Protocol (TCP) retransmission, while Open Shortest Path First (OSPF) uses its own reliable retransmission mechanism), a long control plane outage may break protocol adjacencies and cause protocols to reconverge.

One method to migrate a VR control plane is to check-point the VRcp, copy the memory pages to the destination VRcp, and restore the VR. This approach is referred to as stall-and-copy and leads to downtime that is proportional to the memory size of the VR being copied (step 515).

Another method to migrate a VR control plane is to add an iterative pre-copy phase before a final stall-and-copy phase (step 517). FIG. 4 shows the iterative pre-copy (timing step 3-1) as a part of memory copy. All memory pages are transferred in the first round of the pre-copy phase, and in subsequent rounds, only pages that are modified during the previous round are transferred. The number of pre-copy iterations depends on the amount of change that takes place between iterations. For example, if no pages are modified, then additional iterations are not required. If change continues to occur, then the migration may be forced after a set number of iterations, which may be system and/or workload specific. The pre-copy phase reduces the number of pages that need to be transferred during the stall-and-copy phase, reducing the control plane downtime of the VR. FIG. 4 shows the control plane is only “frozen” between t3 and t4.

The two methods of control plane migration may be extended to migrate the data plane, i.e., copy all data plane states over to the new physical node. However, these approaches have two drawbacks. First, copying the data plane states (e.g., FIB, ACLs) is unnecessary and wasteful because the information that is used to generate these states (e.g., RIB, configuration files) is available in the control plane. Second, copying the data plane state directly may be difficult if the source and destination routers use different data plane technologies. For example, some routers may use Ternary Content-Addressable Memory (TCAM) in their data planes, while others may use regular Static Random Access Memory (SRAM). As a result, the data structures that hold the state may be different.

Since the router is migrated, the original VR1's control plane version is copied across to router B and source router A's VR1 control plane is vacant (step 519).

Embodiments formalize the interface between the control and data planes using the data plane hypervisor 209 which allows a migrated control plane to reinstantiate its data plane at a destination router. This is referred to as data plane cloning. Only the control plane of a VR is migrated. Once the control plane is migrated to a destination router, the destination router clones the data plane for the migrated VRcp by repopulating the FIB using its RIB and reinstalling ACLs and other data plane states 2 through the data plane hypervisor (step 521). The data plane hypervisor 209 provides a unified interface to a control plane that hides the heterogeneity of the underlying data plane implementations, enabling virtual routers to migrate between different types of data planes.

Referring to FIG. 3B, after VR1's control plane VR1cp is migrated from router A to router B, the next steps are to clone (repopulate) VR1's data plane VR1dp at router B and then migrate the links from source router A to destination router B. The cloning of the new data plane cannot be performed instantaneously due to the time it takes to install FIB entries. Installing one FIB entry typically takes between one hundred and a few hundred microseconds. Therefore, installing the full Internet BGP routing table (about 250 k routes) may take over 20 seconds. During this period, although data traffic can still be forwarded by the data plane on router A, all the routing instances in VR1's control plane VR1cp can no longer send or receive routing messages since during this time, the control plane is not executing (frozen), so no control plane messages are processed. The longer the control plane remains unreachable, the more likely it will lose its protocol adjacencies with its neighbors.

To overcome this problem, router A's substrate 203 starts redirecting all the routing messages destined to VR1 at source router A to destination router B at the end of the control plane migration (FIG. 4, t4) (step 523). To avoid introducing any delay to the control plane downtime, the tunnels for each of VR1's substrate interfaces are established before the control plane migration (FIG. 3A). Using this redirection mechanism, VR1's control plane VR1cp not only can exchange routing messages with other network routers, it can also act as the remote control plane for its old data plane on source router A and continue to update the old FIB when routing changes happen.

After the data plane VR1dp is cloned at destination router B (FIG. 4, timing step 4), the data planes on source router A and destination router B can forward traffic simultaneously. By employing double data planes, links may be migrated from source router A to destination router B, one at a time, in an asynchronous fashion (FIG. 3C) (step 525). After asynchronous link migration (FIG. 4, timing step 5), the data plane on source router A may be disabled (FIG. 3D).

At the end of data plane cloning, VR1 can switch from its data plane at source router A to its data plane at destination router B by migrating all of its links from router A to router B simultaneously. However, performing accurate synchronous link migration across all the links is challenging, and could significantly increase the complexity of the system (because of the need to implement a synchronization mechanism).

Because VR1 has two data planes ready to forward traffic at the end of the data plane cloning step, the migration of its links does not have to happen all at once. Instead, each link can be migrated independent of the others, in an asynchronous fashion (FIGS. 3C and 3D). This property reduces the complexity of link migration. During link migration, source router A redirects routing protocol traffic to destination router B. Once the data plane is fully populated at destination router B, link migration can begin. Both data planes operate simultaneously for a period of time to facilitate asynchronous migration of the links.

Once all of VR1's links are migrated to destination router B, the data plane at source router A, as well as the temporary tunnels, may be removed (step 527). This marks the end of the migration process.

Embodiments provide a simple solution to conventional network management tasks and also enable new network management solutions to emerging challenges such as power management. As network traffic volume decreases at night, VRs can be migrated to a smaller set of routers and the unneeded routers may be shut down or put into hibernation to save power. When traffic begins to increase, the hibernating routers may be brought on-line and the VRs can be migrated back accordingly. Embodiments keep the IP layer topology intact during migrations so that power savings does not come at the price of user traffic disruption, reconfiguration overhead or protocol reconvergence. Analyses of data traffic volumes in a Tier-1 ISP backbone suggests that applying the above described embodiments, power management could save 18-25% of the power required to run routers in a given network.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for a packet-aware transport network to allow a Virtual Router (VR) to migrate from a source router to a destination router comprising:
prior to migrating a VR, searching for a destination router that does not increase path stretch and is in accordance with physical constraints;
receiving a migrate order at a source router and at a destination router from a Network Management System (NMS) to migrate a VR;
establishing temporary tunnels between the source router and destination router;
copying the VR's configuration files at the source router to the file system at the destination router;
cloning the data plane for the migrated VR at the destination router;
redirecting all routing messages destined to the VR at the source router to the destination router;
migrating each link to and from the source router to the destination router, migrating each link independently of the others; and
after all links are migrated to the destination router, removing the VR data plane at the source router and the temporary tunnels.

2. The method according to claim 1 wherein copying the VR's configuration files to the file system at the destination router further comprises a stall-and-copy.

3. The method according to claim 1 wherein copying the VR's configuration files to the file system at the destination router further comprises an iterative pre-copy and final stall-and-copy.

4. The method according to claim 1 wherein cloning the data plane for the migrated VR further comprises repopulating the destination router's VR Forwarding Information Base (FIB) using the control plane Routing Information Base (RIB) and reinstalling Access Control Lists (ACLs) and other data plane states for the migrated VR's data plane.

5. The method according to claim 1 further comprising continuing to update the data plane state at the source router when the migrated VR's data plane is being cloned at the destination router.

6. The method according to claim 1 further comprising temporarily forwarding packets using the source router and destination router data planes to support asynchronous migration of network links from the source router to the destination router.

7. The method according to claim 1 further comprising configuring routers as carrier substrates on which VRs operate.

8. The method according to claim 1 further comprising not changing the logical topology of the network thereby obviating the need to reconfigure the VRs and avoiding routing protocol convergence delays.

9. The method according to claim 1 wherein to enable VR migration and link migration, the source and destination routers dynamically set-up and change the binding between a VR's FIB and its substrate interfaces.

10. A router architecture that provides router virtualization, control and data plane separation, and dynamic interface binding which enables one or more resident Virtual Routers (VRs) to migrate to another router comprising:
a physical substrate coupled to one or more physical interfaces and coupled to one or more tunnel interfaces;
a data plane hypervisor configured to interface between the physical substrate and one or more VR control planes and their respective data planes, and decouple VR control plane software from VR control plane state, a VR's control and data plane separation allows the router architecture to migrate the control and data planes of a VR separately; and
a dynamic interface binding configured to allow data structures associated with a particular VR data plane to be dynamically associated with different physical interfaces wherein the isolation between the one or more VRs allows migration of one resident VR without affecting another resident VR and enables VR migration and link migration by dynamically setting-up and changing the binding between a VR's Forwarding Information Base (FIB) and its substrate physical interfaces and tunnel interfaces.

11. The router architecture according to claim 10 wherein each VR runs independently with its own control plane and data plane.

12. The router architecture according to claim 11 wherein a VR control plane runs in a physical control processor of the router and the VR's data plane may be a partition of a router data plane.

13. The router architecture according to claim 12 wherein a VR control plane includes applications, configurations, routing protocol instances and a Routing Information Base (RIB).

14. The router architecture according to claim 12 wherein a VR data plane includes interfaces, FIB entries and Access Control Lists (ACLs).

15. The router architecture according to claim 10 wherein the data plane hypervisor further comprises:
a first module configured to separate forwarding tables from container contexts;
a second module configured to push the forwarding table entries into a separate data plane; and
a third module configured to dynamically bind virtual interfaces and the forwarding tables.

16. The router architecture according to claim 10 wherein the dynamic interface binding is a configurable switching fabric local to the router.

17. The router architecture according to claim 10 wherein the router architecture partitions resources to support one or more VR instances.
